(19) United States
(12) Patent Application Publication
(10) Pub. No.: US 2010/0262508 A1
(43) Pub. Date: Oct. 14, 2010

(54) METHOD AND SYSTEM FOR AN ONLINE LIBRARY MARKETPLACE

(76) Inventor: Will Volnak, Santa Cruz, CA (US)

Correspondence Address: WEST & ASSOCIATES, A PC, 1255 Treat Blvd., 3rd Floor, WALNUT CREEK, CA, 94597, US

(21) Appl. No.: 12/422,055

(22) Filed: Apr. 10, 2009

(51) Int. Cl. G06Q 30/00

(52) U.S. Cl. 705/26

(57) ABSTRACT

A method and system for online library marketplace are disclosed. According to one embodiment, a method comprises receiving a first user input from a first user. The first user input establishes ownership rights to a non-modifiable data object stored in a permanent archive. A second user input is received from the first user, the second user input selecting a first fee for a second user to pay to access the non-modifiable data object. Access is granted to the non-modifiable data object to the second user upon payment of the first fee.

### FIELD

The present invention relates to the field of computer systems. In particular the present invention discloses a method and system for an online library marketplace.

### BACKGROUND

The Internet can deliver a flood of email, instant messages, and; web pages to users, making preservation and retrieval of the information quite challenging. Existing email programs become overloaded due to overflowing inboxes. Instant messages, by their nature, are typically erased upon exiting a conversation. Databases can require, a structure that electronic information does not naturally possess. Search engines can return too many results, while retrieving too little information about those results. Quite importantly, web pages disappear or change making bookmarks or any research tied to them useless.

U.S. Pat. No. 6,694,357 filed Jul. 2, 1998 discloses a system for accessing, viewing, and manipulating data stored in a computer system, and is hereby incorporated in its entirety by reference. The data stored in a computer system for accessing, viewing, and manipulating are in the form of non-modifiable data objects. The system provides for an enhanced journaling system and is the basis for the present invention. The system of U.S. Pat. No. 6,694,357 has various limitations which are eliminated by the present invention.

One limitation of the system disclosed in U.S. Pat. No. 6,694,357 is the lack of an ongoing financial relationship with the provider and the user. A one time transaction takes place between the provider and the user, wherein the user purchases and/or downloads the application for use. Another limitation is the system does not allow users to charge a fee for viewing a published entry. A user may be interested in profiting from an entry he/she has published or the user may be interested in selling the rights to an entry, and the next user may wish to re-sell those rights. All of the transactions enabling viewer-fees and resale of rights would require appropriate security mechanisms be in place to prevent unauthorized use or distribution, which is lacking in the system of U.S. Pat. No. 6,694,357. Finally, the system does not allow for automatic importation of entries from other libraries, importation of entries is entirely manual.

### SUMMARY

A method and system for an online library marketplace are disclosed. It is an object of the system to solve the limitations described above. The system provides for an online library marketplace in which a user may access, store, and manipulate non-modifiable data objects, as well as publish them for a fee and re-sell rights to them. Additional enhancements to the system in U.S. Pat. No. 6,694,357 include the ability to subscribe to a designated source for automatically importing entries into a user's library, rather than the user having to manually import every entry. The enhancement which provides for charging a fee for viewing or for rights to an entry, as well as re-selling the rights, is made possible by a subscription based nature of the system, in one embodiment.

The subscription based nature sets up an ongoing financial relationship between the user and the provider, allowing for revolving billing and crediting related to viewing/selling/reselling of entries. For the protection of the rights to entries, a security system is in place in one embodiment to prevent unauthorized access to protected entries. The security system is implemented using public-key encryption in one embodiment.

According to one embodiment, a method having one or more computers comprises receiving a first user input from a first user. The first user input establishes ownership rights to a non-modifiable data object stored in a permanent archive. A second user input is received from the first user, the second user input selecting a first fee for a second user to pay to access the non-modifiable data object. Access is granted to the non-modifiable data object to the second user upon payment of the first fee.

### BRIEF DESCRIPTION OF DRAWINGS

The accompanying drawings, which are included as part of the present specification, illustrate the presently preferred embodiment of the present invention and together with the general description given above and the detailed description of the preferred embodiment given below serve to explain and teach the principles of the present invention.

FIGS. 1A and 1B are diagrams depicting prior art relating to journaling and library system.

FIG. 1C is a block and flow diagram depicting an exemplary layout and communication in an online library marketplace system, according to one embodiment.

FIG. 2 is a process flow diagram for the progress of an entry in an online library marketplace system, according to one embodiment.

FIG. 3 is a process flow and system diagram for comparison and communication between an online library marketplace system and existing internet-based systems, according to one embodiment.

FIGS. 4A and 4B are block diagrams of members only libraries in an online library marketplace system, according to one embodiment.

FIG. 5 is a system level block diagram of the user's relationship to the provider and an online library marketplace system, according to one embodiment.

FIG. 6 is a block diagram depicting a free library reader system of an online library marketplace system; according to one embodiment.

FIG. 7 is a process flow diagram of communication between a buyer and seller of entries in an online journal system, according to one embodiment.

FIG. 8 is a process flow diagram depicting the establishing of user H-mail relationships in an online library marketplace system, according to one embodiment.

FIG. 9 depicts exemplary selections within a library search engine in an online library marketplace system, according to one embodiment.

FIG. 10 is an exemplary form to select publishing rights to an entry in an online library marketplace system, according to one embodiment.

FIG. 11 is a process flow diagram of the financial relationship between a user and an online library marketplace system, according to one embodiment.

The above and other preferred features, including various novel details of implementation and combination of elements, will now be more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the teachings herein.

### DETAILED DESCRIPTION

A method and system for an online library marketplace are disclosed. According to one embodiment, a method comprises receiving a first user input from a first user. The first user input establishes ownership rights to a non-modifiable data object stored in a permanent archive. A second user input is received from the first user, the second user input selecting a first fee for a second user to pay to access the non-modifiable data object. Access is granted to the non-modifiable data object to the second user upon payment of the first fee.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories, random access memories, EPROMs, EEPROMs, magnetic or optical cards, or any type of media suitable for storing electronic instructions, and each coupled to a computer system bus.

The methods presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

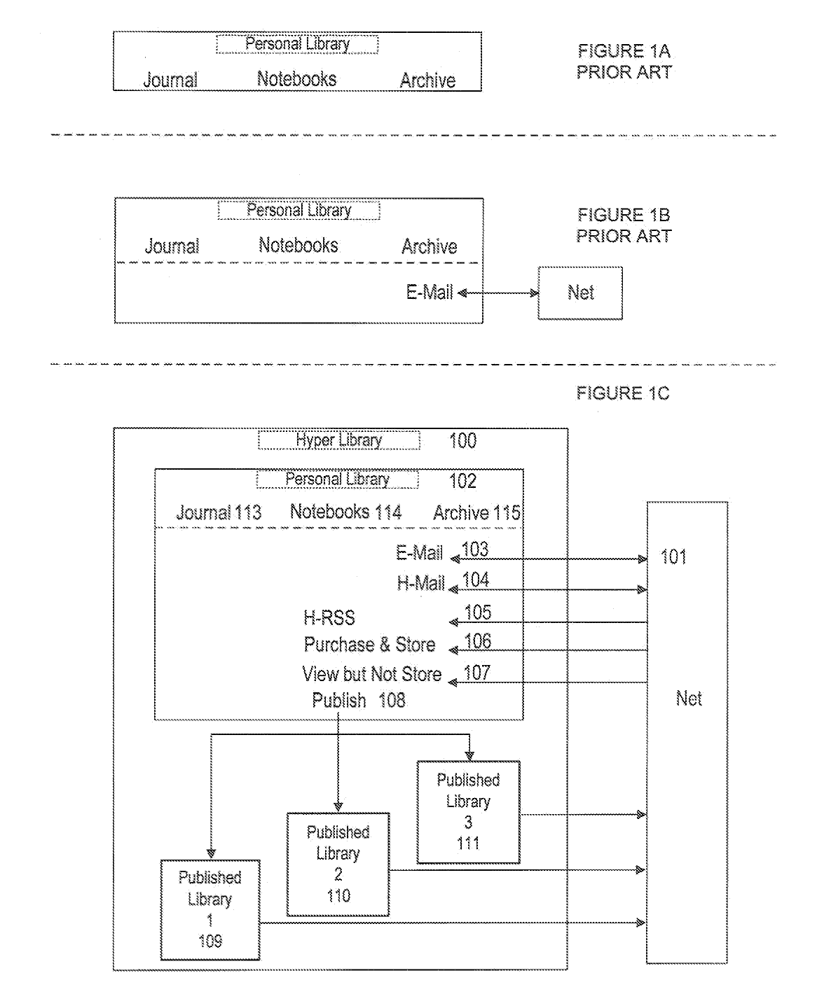

FIGS. 1A and 1B are diagrams depicting prior art relating to journaling and library system. Prior art systems typically involve journaling, archiving, and improvements related to Internet accessibility.

FIG. 1C is a block and process diagram depicting an exemplary layout and communication in an online library marketplace system, according to one embodiment. A hyper library 100 contains a personal library 102 and published libraries 109, 110, 111. A personal library 102 contains a journal 113, notebooks, 114, and an archive 115. A user may subscribe to H-RSS 105, purchase and store entries 106, view but not store an entry 107, and publish notebooks 108. Email 103 and h-mail 104, an exemplary personalized e-mail interface specific to the journaling and library system software, are accessible within a user's personal library 115. The hyper library is in communication with the Internet 101 in various ways. Email 103 and h-mail 104 require access to the Internet 101. H-RSS 105 is received from the Internet 101, purchasing and storing 106 an entry requires receipt of the entry via the Internet 101. Viewing 107 an entry requires Internet 101 access, and when a user publishes 108 a library the published libraries 109, 110, 111 become accessible via the Internet 101. A user may set chores, which are time delayed user actions. A user may also send entries to him/herself at a designated time in the future.

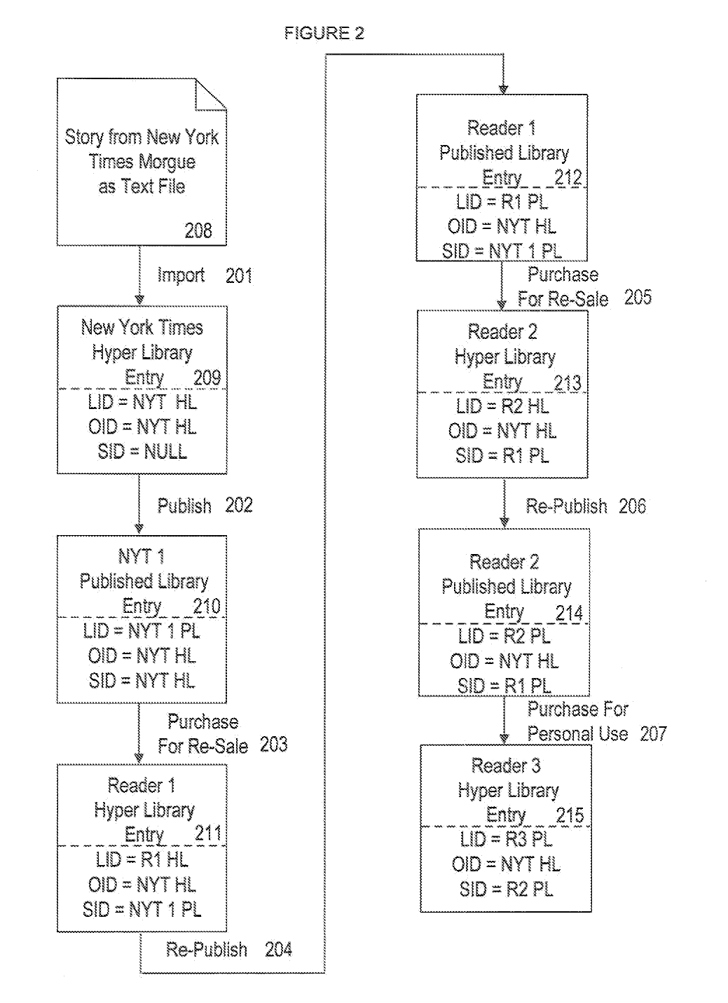

FIG. 2 is a process flow diagram for the progress of an entry in an online library marketplace system, according to one embodiment. Each entry has a library ID (LID), an originator ID (OID) and a source ID (SID). To aid in understanding, an originator ID may be thought of as a birthplace, a source ID may be thought of as a previous address, and a library ID may be thought of as a current residence. As an example, an entry is first created in the New York Times Hyper Library 209 by importing 201 the scanned text of an ancient article in the New York Times morgue 208. The New York Times Hyper Library (NYT HL) entry now has a LID set to NYT HL, and an OID also set to NYT HL. The entry's SID is null at this point.

The NYT HL library entry 209 may be published 202, and becomes an NYT published library (NYT PL) entry 210. The NYT published library entry 210 now has an LID set to NYT PL, an OID set to NYT HL, and an SID set to NYT HL.

The NYT 1 PL entry 210 may be purchased for re-sale 203 by a reader. The entry becomes Reader 1 Hyper Library (R1 HL) Entry 211, with an LID set to R1 HL, an OID set to NYT HL, and the SID set to NYT 1 PL.

The R1 HL entry 211 may be re-published 204. The entry becomes Reader 1 published library (R1 PL) entry 212, with the LID set to R1 PL, OID set to NYT HL, and SID set to NYT 1 PL.

The R1 PL entry 212 may be purchased for re-sale 205. The entry becomes reader 2 hyper library (R2 HL) entry 213, with LID set to R2 HL, OID set to NYT HL, and SID set to R1 PL.

The R2 HL entry 213 may be re-published 206, becoming the reader 2 published library (R2 PL) entry 214. The R2 PL entry has an LID set to R2 PL, OID set to NYT HL, and SID set to R1 PL.

The R2 PL entry 214 may be purchased for personal use 207, becoming reader 3 hyper library (R3 HL) entry 215. The R3 HL entry has an LID of R3 HL, OID of NYT HL, and SID of R2 PL.

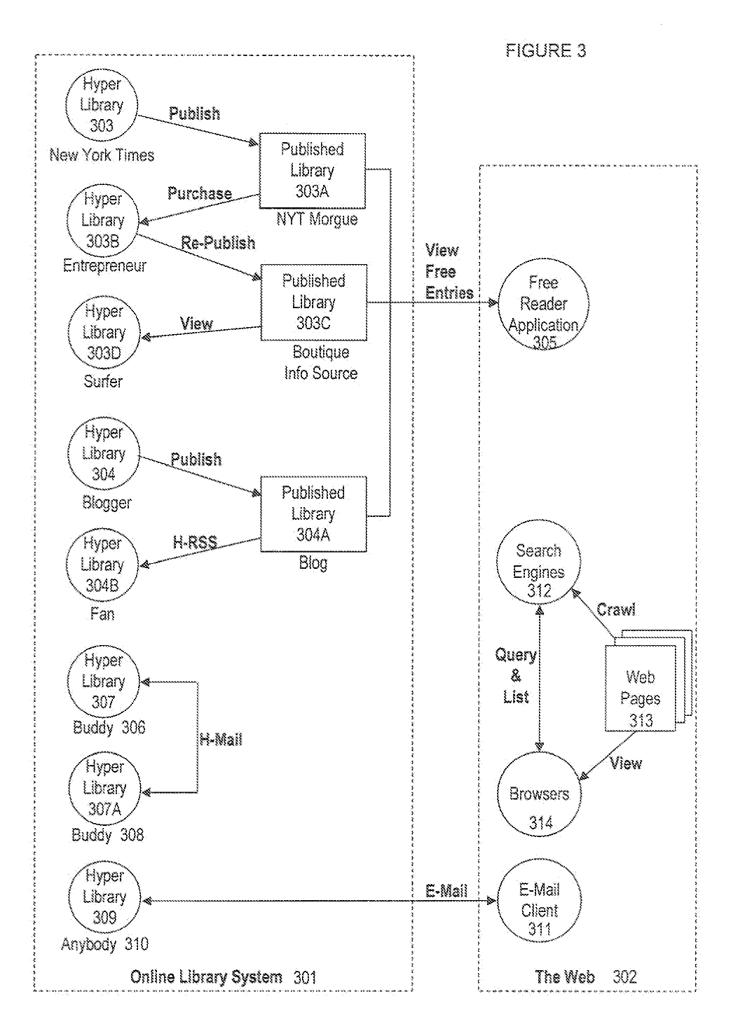

FIG. 3 is a process flow and system diagram for the relationship between an online library marketplace system and the internet, according to one embodiment. Systems with online library marketplace system 301 software on them may conduct a variety of actions on libraries. As an example, the New York Times may publish entries from its hyper library 303 to create a published library 303A called the NYT Morgue. A user, in this case an entrepreneur, may purchase the entry so that it is placed within the user's hyper library as an entry 303B. The entrepreneur may republish the entry in a boutique information source 303C, and finally a surfer of online library marketplace system may view the library as an entry 303D within his or her hyper library. As another example, a blogger may publish an entry 304 from his or her hyper library. It then becomes an entry within a published library 304A serving as a blog. A fan of the blog may subscribe using H-RSS and receive the newly published library entry from 304A as an entry in his or her hyper library 304B. H-RSS is an improved RSS wherein a user of the online library marketplace system 301 explicitly subscribes to a hyper library and newly published entries arrive as deletable journal entries or can be immediately archived if the user so desires.

According to one embodiment, H-RSS requires the subscriber to regularly poll the publishing library using the online marketplace software to see if new entries have been created. If so, the subscriber's hyper library automatically imports those new entries. According to the same embodiment, in H-mail the sender's hyper library copies the message entry as a file to a folder on the web. The folder is on a server that is always accessible online, such as at the user's ISP (internet service provider) or online library marketplace system provider. Just as with commonly available email, when the user connects to the internet the user's hyper library software synchronizes with the folder.

Another user capability within an online library marketplace system 301 is the ability to establish buddy relationships and communicate with buddies via h-mail. A user, here a buddy 306, may create and archive an entry in his or her hyper library 307. Via h-mail, the selected buddy 308 receives a copy of buddy 306's entry from buddy 306's hyper library 307 to his or her own hyper library 307A. Anybody 310 may email an entry from his/her own hyper library 310 to an email client 311 outside of online library marketplace system 301 at any time.

Outside of online library marketplace system 301 lies the internet space or the web 302. Interaction with online library marketplace system 301 via the web 302 may be as follows, according to one embodiment. A free reader application 305 for access to online library marketplace system libraries may be utilized on a user system to view free entries within online library marketplace system 301 in a limited fashion. Aside from an email client 311 receiving an entry from hyper library 309 as an ordinary email message from an online library marketplace system 301 user and the free reader application 305, the web 302 cannot access libraries within online library marketplace system 301. Search engines 312 crawl web pages 313, and interact with browsers 314 to list results associated with a desired query. The web pages 313 are viewable via browsers 314. In one embodiment, third party plug-ins may exist to play various types of media. According to the same embodiment, player hardware may be linked to a library to enable listening to music or viewing movie media, Users can flag entries to protect children from accessing certain content, and the library software respects the flagging restrictions.

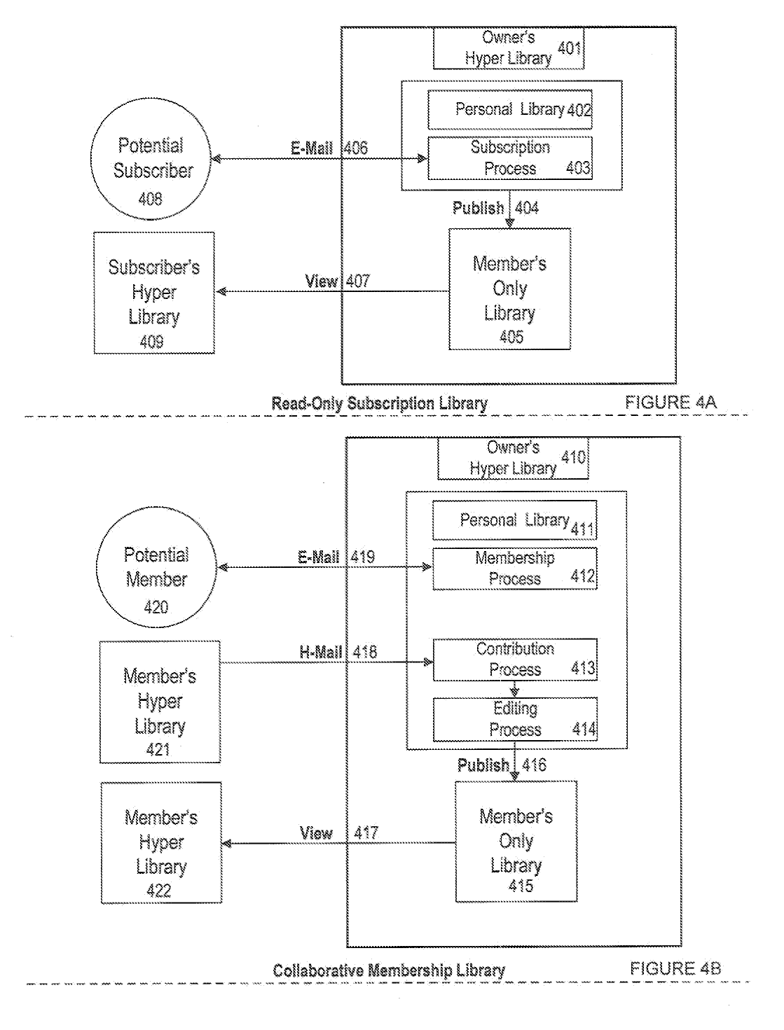

FIGS. 4A and 4B are block diagrams of members only libraries in an online library marketplace system, according to one embodiment. Within online library marketplace system users may establish members only libraries. For a read-only subscription library in FIG. 4A, an owner of a hyper library 401 may establish and publish 404 from their own personal library 402 a members only library 405. A potential subscriber 408 may email 406 the owner 401 of the members only library 405 and go through the subscription process 403. Once the subscription process 403 is complete the subscriber may view 407 the members only library 405 from the subscriber's hyper library 409.

In the case of a collaborative membership library in FIG. 4B, an owner of a hyper library 410 may establish and publish 416 from their own personal library 411 a members only library 415. A potential member 420 may email 419 the owner 410 of the members only library 415 and go through the membership process 412. Once the membership process 412 is complete the member may utilize h-mail 418 to go through the contribution process 413 and the editing process 414 in order to also publish 416 to the members only library 415. The member may also now view 417 the members only library 415 from the subscriber's hyper library 422.

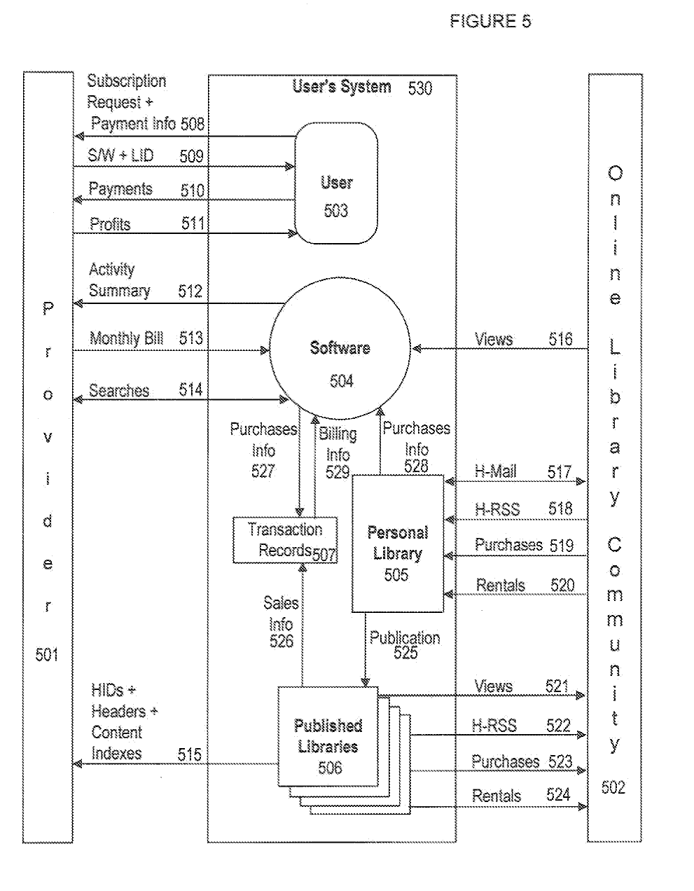

FIG. 5 is a system level block diagram of the user's relationship to the provider and an online library marketplace system, according to one embodiment. One embodiment of an online library marketplace system involves a relationship between a governing corporation, as an example provider 501, a user's system 530, and the online library community 502. Provider 501 is in communication with the user 503 on the user's system 530 to receive subscription request and payment information 508. Provider 501 then provides the user 503 with online library marketplace system software and a library ID 509. Provider 501 collects payments 510 from the user 503, and disburses profits 511 to the user 503. Provider 501 is also in communication with the online library marketplace system software 504 residing on the user's system 530. Online library system software 504 sends an activity summary 512 to provider 501, and provider 501 provides a monthly bill 513 to the online library marketplace system software 504. Searches 514 can be initiated by user via online library marketplace system software 504 and completed by provider 501. Provider also receives hyper IDs, headers, and content indexes 515 of entries in published libraries 506 from the user's system 530.

On the user's system 530; online library marketplace system software manages personal library 505. Online library system software 504 receives purchases information 528 from personal library 505. Online library system software 504 provides purchases information 527 for transaction records 507, which also receive safes information 526 regarding published libraries 506. Online library marketplace system software 504 then receives the transaction records 529 for billing communication with provider 501 at a later time. From the personal library 505 a user may publish 525 entries in libraries 506 to be viewable 521, sent via H-RSS 522, purchased 523, or rented 524 as entries in published libraries 506 by other online library marketplace system 502 users. According to one embodiment, the provider 501 sets a fixed viewing fee for all published entries, and publishing users decide whether the fee applies to their entry or if their entry may be viewed for no fee. The provider 501 may receive a transaction fee on paid views and sales of entries. Also within a user's personal library 505, the user may communicate via h-mail 517 with other online library marketplace system 502 users, or receive H-RSS 518 feeds via subscribing through online library marketplace system 502. Any purchases 519 or rentals 520 from online library marketplace system also reside in the personal library 505. When the user views 516 libraries within online library marketplace system 502, online library marketplace system software 504 manages the viewing 516.

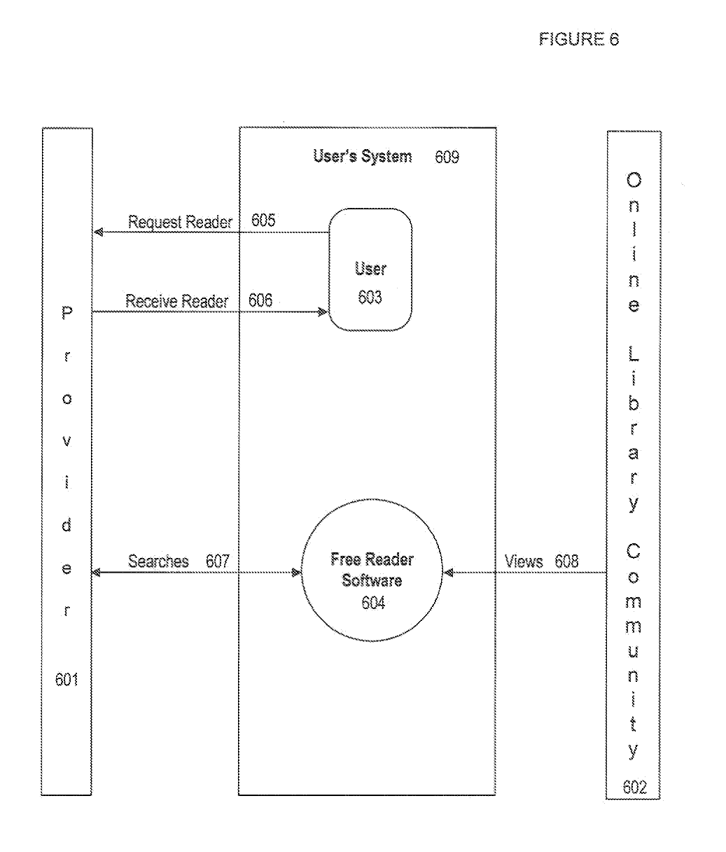

FIG. 6 is a block diagram depicting a free reader application of an online library marketplace system, according to one embodiment. A user 603 requests the reader 605 from provider 601 and receives the reader 606 from provider 601. The free reader software 604 is then installed and resides on the user's system 609. The free reader software 604 communicates with provider 601 to perform searches 607, and receives access to view 608 entries from the online library community 602. According to one embodiment, hyperlinks to entries provide viewing access.

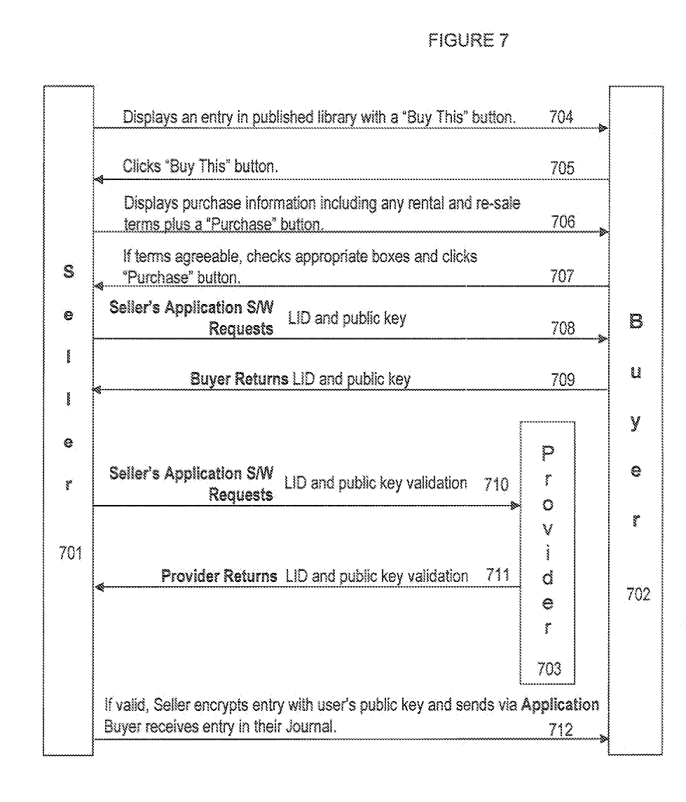

FIG. 7 is a process flow diagram of communication between a buyer and seller of entries and a system provider in an online library marketplace, according to one embodiment A seller 701 displays 704 an entry in a published library with a “Buy This” button, and a buyer 702 may click 705 the button to purchase the entry. The seller 701 may display 706 purchase information, including any rental or re-sale terms, with additional forms to complete the transaction. The buyer 702 can agree 707 to the terms and make additional selections prior to completing the transaction. Once the purchase is complete, the seller's library software requests 708 the buyer's 702 library ID and public key, and the buyer's 702 library software provides 709 the seller 701 with the requested items. The seller's 701 library software requests 710 validation of the buyer's 702 library ID and public key from the provider 703, and the provider responds 711 appropriately based upon whether the information is valid or not. If valid, the seller 701 encrypts the purchased entry with the buyer's 702 public key and sends it via 712 the application, the buyer 702 then receives the entry in their journal. Both the buyer 702 and the seller 701 record this transaction and use it to create a monthly summary that is transmitted to the provider 703 for billing. The transaction may later be deleted, exported, or stored permanently according to the user's preference.

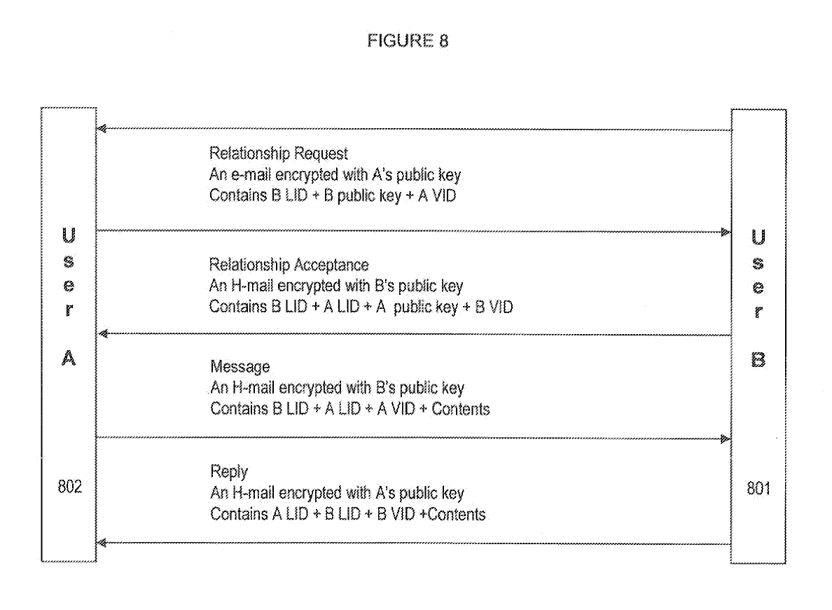

FIG. 8 is a process flow diagram depicting the establishing of user relationships in an online library marketplace system, according to one embodiment. A user B 801 may request a relationship with user A 802 by sending an encrypted email with user A's 802 public key. The relationship request contains the library ID (LID) of user B 801, user B's 801 public key, and user A's VID. User A 802 may accept the relationship request by sending an H-mail relationship acceptance encrypted with user B's 801 public key. The relationship acceptance H-mail may contain user B's 801 library ID (LID), user A's 802 library ID (LID), user A's 802 public key, and user B's 801 VID. A VID is a unique validity ID created by one user to identify another. Once a relationship has been established between user B 801 and user A 802, user A 802 may send user B 801 a message via H-mail (an H-mail encrypted with user B's 801 public key). The message may contain user B's 801 library ID (LID), user A's 802 library ID (LID), user B's 801 VID, and the contents user A 802 elected to transmit. User B 801 may respond to a message from user A 802, via an H-mail encrypted with user a's 802 public key. The message contains user A's 802 library ID (LID), user B's 801 library ID, user B's 801 VID, and the message contents.

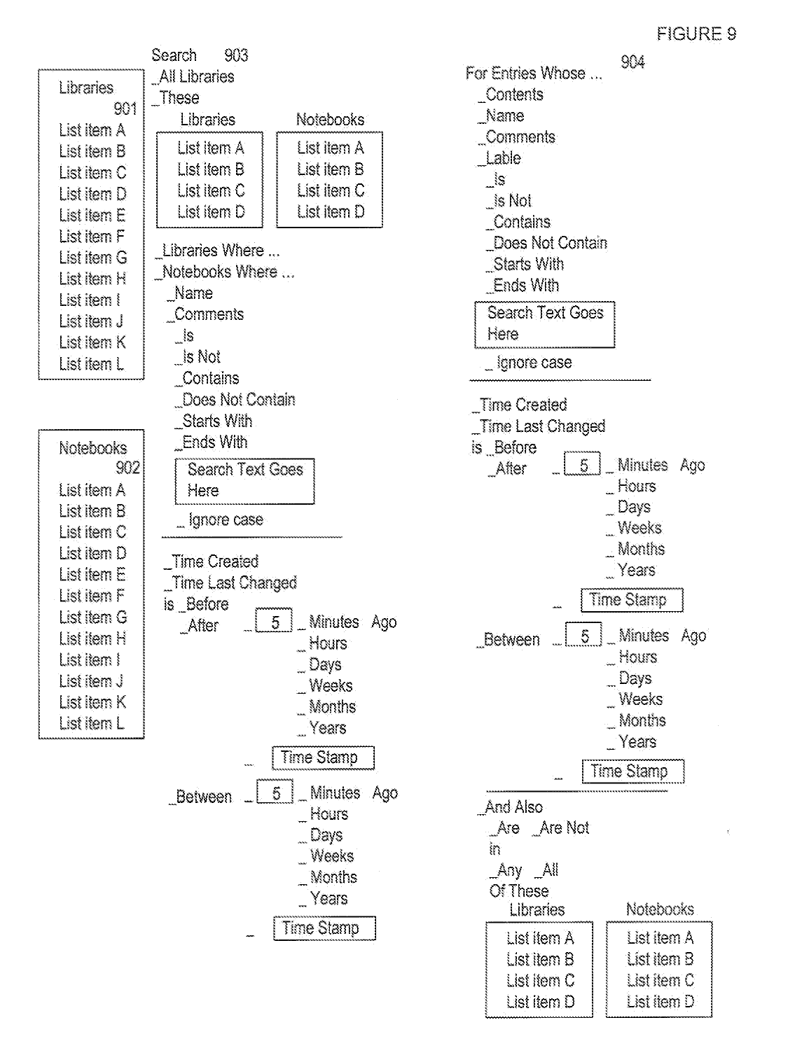

FIG. 9 depicts exemplary choices a user might make when using a library search engine in an online library marketplace system, according to one embodiment. The exemplary interface provides an area for users to search 903, based upon select criteria. The user may specify which libraries 901 or notebooks 902 to search, and the user can narrow based on notebooks 902, or timestamps. Additional search details can be provided for entries 904, and may include keywords or timestamps, as examples. The library search engine can also rely solely on an index of an entry created when it is first published and as a result not crawl libraries, according to one embodiment.

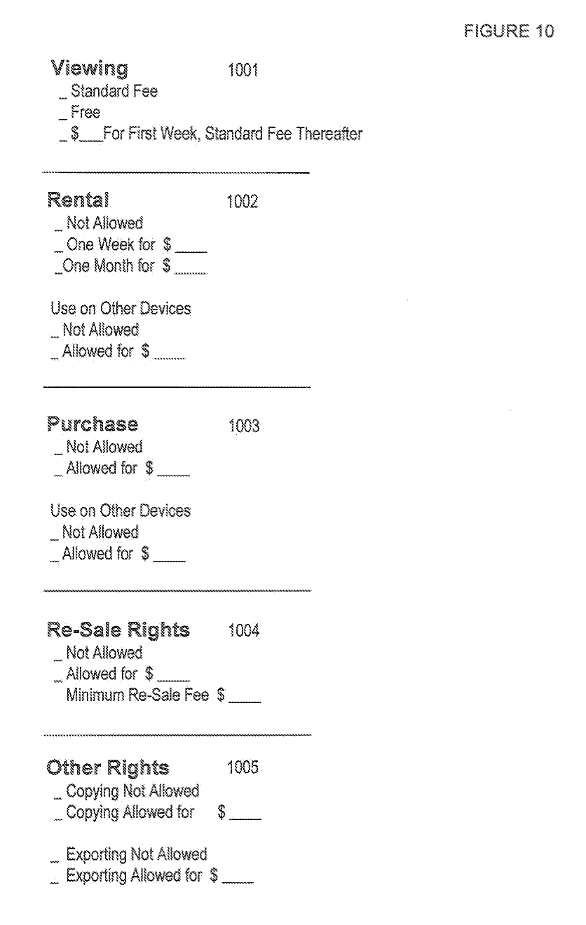

FIG. 10 is an exemplary form to select publishing rights to entries in an online library marketplace system, according to one embodiment A user publishing an entry may select whether other users have to pay a standard fee or nothing for viewing 1001 the entry. Users may also purchase ‘gift’ entries and send them to friends. The user may want to turn the published entry into a rental 1002, in which case the user may specify how much the entry rental will cost per month, among other selections. An entry may be available for purchase 1003 by another user, and a published entry may be available for re-sale 1004 wherein another user may republish the entry and sell it while providing the original user/publisher a royalty. Other rights 1005 may be specified by the user or administrator. Entries may be viewed on a limited basis, and scrolling pasta certain point in the entry may automatically trigger a viewing fee. In another embodiment, the viewing user may be prompted before scrolling too far and automatically incurring a viewing fee.

According to another embodiment the fee for viewing an entry may vary over time. For example, a publisher of an entry can, for a set period of time, establish a higher fee for viewing an entry than the fee the provider has established. The set period of time varies based on the type of publisher, as an example a newspaper publisher might select a higher fee for the first week an entry is published. Thereafter viewing fees continue according to the schedule determined by the provider. An example of such an option is shown in 1001 of FIG. 10.

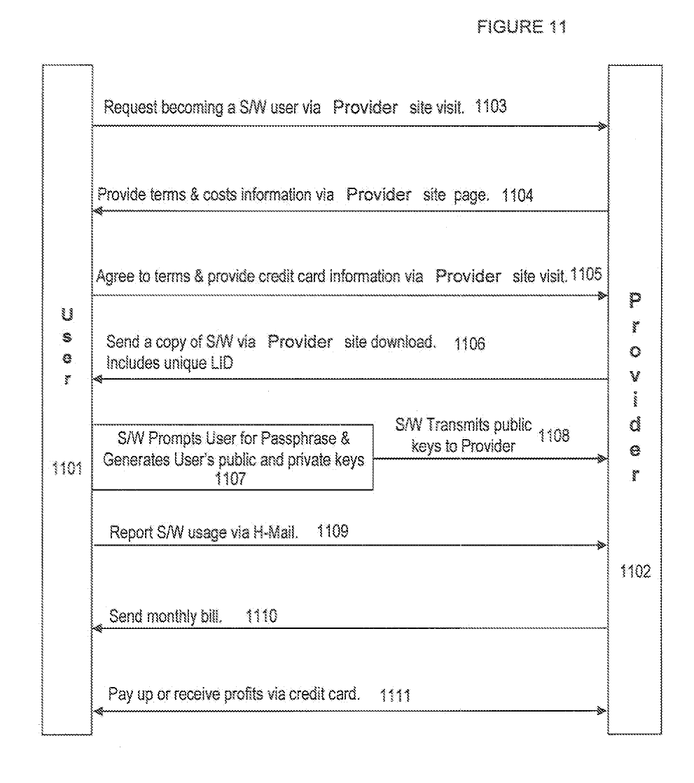

FIG. 11 is a process flow diagram of communication between a user and an online library marketplace system provider, according to one embodiment. The user 1101 may request 1103 to become an online library marketplace system user via the provider's 1101 web interface. The provider 1102 provides 1104 terms and cost information on the interface, and the user 1101 agrees 1105 to the terms and provides a method of payment to the provider 1102. The user 1101 downloads 1106 the online library marketplace system software from the provider's 1102 website (includes a unique library ID). Upon installation, the online library marketplace system software prompts the user at a step 1107 for a long passphrase, and uses the long passphrase to generate the user's public and private keys. The public keys are transmitted to the provider 1102 at a step 1108, and the provider 1102 stores them for validation purposes. Periodically library system usage by the user 1101 is transmitted 1109 to the provider 1102 via H-mail, this way the provider 1102 may send 1110 a monthly (or any other time allotment) bill to the user 1101. If a user has elected to publish entries and receive payment for them, the provider 1102 may send profits 1111 to the user 1101 and the provider 1102 may deduct usage fees from the profits prior to sending. Otherwise the user 1101 may provide a method of payment for usage fees to the provider 1102.

A method and system for an online library marketplace have been disclosed. It is understood that the embodiments described herein are for the purpose of elucidation and should not be considered limiting the subject matter of the present embodiments. Various modifications, uses, substitutions, recombinations, improvements, methods of productions without departing from the scope or spirit of the present invention would be evident to a person skilled in the art.

I claim:

1. A computer-implemented method for providing an online library marketplace, comprising:
receiving a first user input from a first user, the first user input establishing ownership rights to a non-modifiable data object stored in a permanent archive;
receiving a second user input from the first user, the second user input selecting a first fee for a second user to pay to access the non-modifiable data object, and
granting access to the non-modifiable data object to the second user upon payment of the first fee.

2. The method of claim 1, further comprising:
receiving a third user input from the second user, the third user input selecting a second fee for a third user to pay to access the non-modifiable data object; and
granting access to the non-modifiable data object to the third user upon payment; of the second fee; wherein a third fee deducted from the second fee is also paid to the first user;

3. The method of claim 1, further comprising securely transferring funds between users and the system at predetermined time intervals.

4. The method of claim 3, wherein payment information is encrypted.

5. The method of claim 1, further comprising preventing unauthorized access to the non-modifiable data object.

6. The method of claim 5, wherein the non-modifiable data object is encrypted.

7. The method of claim 1, wherein the first fee is waivable.

8. The method of claim 2, wherein the second fee is waivable.

9. The method of claim 1, wherein the first fee changes after a predetermined time interval.

10. The method of claim 2, wherein the second fee changes after a predetermined time interval.

11. The method of claim 1, wherein granting access to a non-modifiable data object comprises allowing a user to view the non-modifiable data object.

12. The method of claim 1, wherein granting access to a non-modifiable data object comprises allowing a user to import the non-modifiable data object as an entry into said user's library.

13. The method of claim 12, wherein the entry is deletable by the user prior to importing the entry into the user's archive.

14. The method of claim 1, wherein granting access to a non-modifiable data object comprises preventing a user from copying the non-modifiable data object.

15. The method of claim 1, wherein granting access to a non-modifiable data object is on a temporary basis.

16. The method of claim 1, wherein granting access to a non-modifiable data object comprises preventing a user from exporting the non-modifiable data object.

17. The method of claim 1, wherein granting access to a non-modifiable data object comprises a user automatically incurring a viewing fee by scrolling beyond a designated fee point in the non-modifiable data object.

18. The method of claim 1, wherein a fifth user purchases a gift viewing for a sixth user.

19. The method of claim 1, further comprising:
automatically importing a non-modifiable data object as an entry to a library belonging to a user based on selective subscription to a non-modifiable data object source.

20. The method of claim 19, wherein the entry is deletable by the user prior to archiving.

21. The method of claim 1, further comprising:
manually importing a non-modifiable data object as an entry to a library belonging to a user.

22. The method of claim 21, wherein the entry is deletable by the user.

23. The method of claim 19, wherein the data object source is a blog.

24. The method of claim 19, wherein the data object source is a RSS feed.

25. The method of claim 19, wherein the data object source is a membership based library.

26. The membership based library of claim 25, wherein a user is granted membership by a designated membership based library owner.

27. The method of claim 1, further comprising limiting viewing access by minors.

28. The method of claim 1, wherein software is available to play media.

29. The method of claim 1, wherein hardware is available to play media.

30. The method of claim 1, wherein a user browses libraries comprising one or more entries, the entries comprising non-modifiable data objects.

31. The method of claim 1, wherein a user creates notebooks, the notebooks comprising references to entries in published libraries, the entries comprising non-modifiable data objects.

32. The method of claim 31, wherein a search engine utilizes the notebooks.

33. The method of claim 1, wherein a search engine utilizes comments.

34. The method of claim 1, wherein a search engine utilizes an index of an entry, an entry comprising a non-modifiable data object.

35. The method of claim 1, wherein a first user establishes an e-mail relationship for sharing non-modifiable data objects with a second user.

36. A system for providing an online library marketplace, comprising:
one or more computers; and
computer instructions executable by the one or more computers, the computer instructions comprising means for:
receiving a first user input from a first user, the first user input establishing ownership rights to a non-modifiable data object stored in a permanent archive;
receiving a second user input from the first user, the second user input selecting a first fee for a second user to pay to access the non-modifiable data object; and
granting access to the non-modifiable data object to the second user upon payment of the first fee.

37. A computer readable storage medium comprising computer instructions for:
receiving a first user input from a first user, the first user input establishing ownership rights to a non-modifiable data object stored in a permanent archive;
receiving a second user input from the first user, the second user input selecting a first fee for a second user to pay to access the non-modifiable data object; and
granting access to the non-modifiable data object to the second user upon payment of the first fee.
